(19) United States
(12) Patent Application Publication
(10) Pub. No.: US 2008/0063999 A1
(43) Pub. Date: Mar. 13, 2008

(54) Tooth Whitening Lens with Bite Plate

(76) Inventor: Joyce A. Osborn, Jasper, AL (US)

Correspondence Address: BUSH INTELLECTUAL PROPERTY LAW GROUP, LLC, P.O. BOX 381146, BIRMINGHAM, AL, 35238, US

(21) Appl. No.: 11/632,561

(22) PCT Filed: Jul. 15, 2005
(86) PCT No.: PCT/US05/25295

§ 371 Date: Jan. 16, 2007

Related U.S. Application Data
(60) Provisional application No. 60/588,418, filed on Jul. 16, 2004.

(51) Int. Cl. A61C 3/00

(52) U.S. Cl. 433/29; 433/215

(57) ABSTRACT

A teeth whitening device having a lens which fits against the teeth. The lens has a casing containing a plurality of light emitting diodes which project light into the lens. The lens filters the light to produce a 430 to 450 nanometer blue light which is projected onto the surface of the teeth. When carbamide peroxide is placed on the surface of the teeth the blue light will activate the peroxide to whiten the teeth several shades within one hour without heating or sensitizing the teeth. The lens has a bite plate which a user bites down on to keep the lens in position against the teeth, leaving the user's hands free. The device and method are safe enough for use outside the dental office.

### TECHNICAL FIELD

This invention relates to tooth whitening devices and methods, and, more particularly, to a lens bite plate to provide blue light for accelerating bleaching at the surface of the teeth.

### BACKGROUND ART

Teeth become stained from various causes, including tobacco, tea, coffee, chemical substances, aging, and disease. Bleaching the teeth is a popular and widely used method for whitening teeth. Bleaching is a processing of decolorizing colored substances by means of a chemical reaction. The most widely used bleaching agents for whitening teeth are peroxides, such as hydrogen peroxide and carbamide peroxide.

Bleaching agents such as peroxides produce whitening by the generation of oxygen free radicals. When used alone peroxides require many hours of contact with the teeth to provide sufficient whitening. Prolonged exposure to peroxide bleaching agents can cause loss of calcium from the tooth enamel and damage to pulp tissue. The rate of bleaching by peroxides can be greatly accelerated by ultraviolet light and by heat, usually from infrared light. However, ultraviolet light can be hazardous to the user, and infrared light can cause irreversible pulpitis.

In order to avoid the deleterious effect of ultraviolet or infrared radiation, blue light has been used at a 400 to 500 nanometer wavelength range to photoactivate peroxides for whitening teeth. However, this approach has required the use of catalysts, activators, photosensitizing agents, or heat. The light source is complex and needs to be held outside the mouth near the teeth. The method is not suitable for use without administration by a dental professional. U.S. Pat. No. 6,416,319 which is incorporated herein by reference, describes this use of blue light projected from a position outside the patient's mouth to produce chemosensitizing actinic radiation having a 400 to 500 nm wavelength range to accelerate the bleaching activity of a peroxide. Because this range of wavelength is near ultraviolet and near infrared it can produce an unwanted heating of the teeth.

What is needed is a device and method for whitening teeth using only a peroxide bleaching agent with blue light which does not heat or sensitize the teeth and which is safe enough and simple enough for use without administration by a dental professional.

### SUMMARY OF THE INVENTION

The present invention is a semi-circular lens having a casing on one side and a bite plate on the opposite side. The shape of the lens conforms to the shape of the arch of the teeth so that it fits around the outer surface of all the teeth. The casing contains a plurality of light emitting diodes (LEDs) which provide light that includes a wave length range of 430 to 450 nm. The lens is placed in the mouth against the teeth and is held in place by a user biting down on the bite plate. The LEDs generate light having a power of 3 to 75 milliwatts/cm² and a beam diameter of 0.1 to 10 mm. The lens transmits blue light only in the range of 430 to 450 nm to the teeth surfaces. To produce an accelerated whitening of the teeth a carbamide peroxide gel is applied to the surface of the teeth. The lens is inserted into the mouth and the user bites down on the bite plate to hold the lens against the teeth. The carbamide peroxide gel is transparent to the blue light generated by the lens so blue light passing through the lens in the range of 430 to 450 nm will reach the surface of the teeth and accelerate the decomposition of the peroxide gel at the surface of the teeth. Ten (10) shades of whitening of the surface of the teeth can occur within 15 minutes. The peroxide bleaching solution does not require an activating component, no appreciable heating or sensitization of the teeth occurs, and the device and method can be used outside the dental office.

An advantage of the present invention is a blue light generating lens that can be held at the surface of the teeth by a user simply biting down on a bite plate.

Another advantage is a method of rapidly whitening teeth that is inexpensive, safe, and easy to use outside the dental office.

Another advantage is that whitening of the teeth can be accomplished within one hour without heating or sensitizing the teeth.

Another advantage is that a carbamide peroxide bleaching gel can be used without the addition of an activator or accelerator to the gel or teeth.

### BRIEF DESCRIPTION OF THE DRAWINGS

FIG. 1 illustrates a rear perspective view of the tooth whitening device of the present invention.

FIG. 2 shows a diagramactic cross-sectional top view of the tooth whitening device positioned in the mouth of a user.

FIG. 3 shows a diagrammatic cross-sectional side view of the tooth whitening device through the front of the mouth.

### BEST MODE FOR CARRYING OUT THE INVENTION

While the following description details the preferred embodiments of the present invention, it is to be understood that the invention is not limited in its application to the details of construction and arrangement of the parts illustrated in the accompanying drawings, since the invention is capable of other embodiments and of being practiced in various ways.

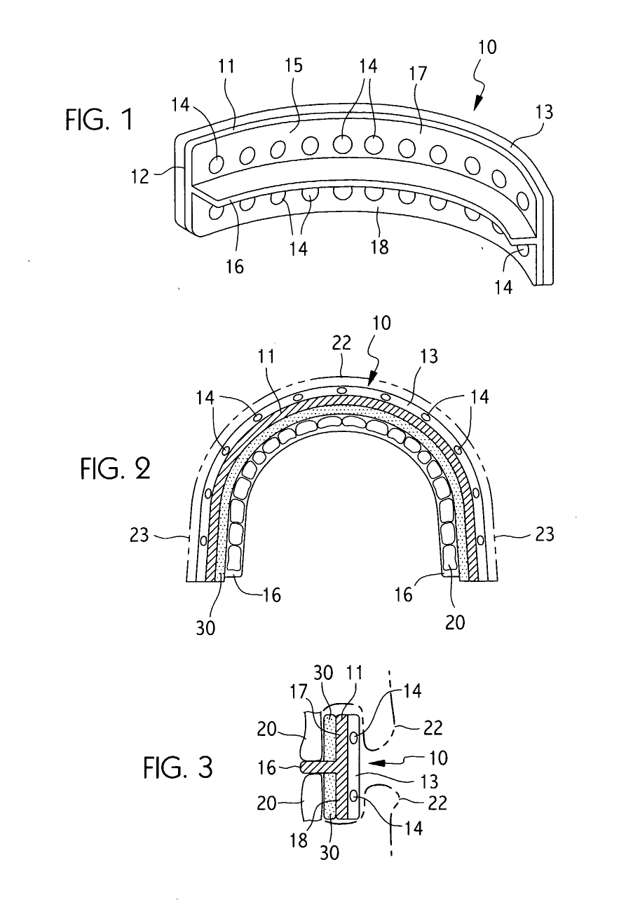

FIG. 1 illustrates the tooth whitening device 10 of the present invention. Lens 11 is curved to fit the curvature of the arch formed by the teeth. On the outside surface 12 of lens 11 a casing 13 is attached which houses a plurality of light emitting diodes (LEDs) 14. On the inside surface 15 of lens 11 is a bite plate 16 which bisects lens 11 into an upper portion 17 which contacts the upper teeth and a lower portion 18 which contacts the lower teeth. FIG. 2 shows a diagramactic cross-sectional top view of tooth whitening device 10 positioned in the mouth of a user. Upper teeth 20 bite down on bite plate 16 fixing the position of bite plate 16 between the upper teeth 20 and lower teeth 21 (see FIG. 3). The lips 22 and cheeks 23 cover the device 10. The teeth 20 are coated with a layer of carbamide peroxide gel 30. FIG. 3 shows a diagrammatic cross-sectional side view of device 10 through the front of the mouth. The LEDs 14 are shown positioned near both the upper portion 17 and lower portion 18 of lens 11.

The preferred peroxide for use in the present invention is carbamide peroxide (CO(NH₂)₂H₂O₂). Other peroxides may be used such as hydrogen peroxide, calcium carbonate peroxide, sodium carbonate peroxide, and other free radical generating agents. The concentration range for carbamide peroxide is 10% to 30% preferably about 21% by weight in a liquid, emulsion, or gel which is transparent to blue light. Carbamide peroxide is the preferred whitening agent in the present method because it was found, surprisingly, not to cause tooth sensitization.

The preferred light to accelerate the whitening action of the peroxide is blue light having a wavelength range of 415 to 480 nanometers, preferably 430 to 450 nanometers, with a power of 3 to 75 milliwatts/cm². The duration of exposure of the teeth to the light is 1 hour or less, depending upon the level of power used. Beam diameter through each lens can range from 0.1 to 10 mm. The lenses are wavelength selection filters known in the art that are constructed to pass desired wavelength ranges, but will not appreciably pass other wavelengths. The lens can be made of plastic, glass, quartz, and the like. The relatively narrow range of blue light (430 to 450 nanometers) will accelerate the decomposition of carbamide peroxide at the surface of the teeth without appreciably heating the teeth. Wider ranges that approach infrared or ultraviolet (400 to 500 nanometers) have a risk of heating teeth. This relatively narrow and specific range of wavelength of blue light used in the present invention has no appreciable ultraviolet or infrared radiation. Consequently, the present invention can safely increase the rate of whitening by the peroxide bleaching agent with no appreciable risk to the user. The bite plate 16 on lens 11 can be made of any suitable material, preferably plastic. Any light source capable of emitting light having the desired wavelength range can be used in the present invention. A preferred light source is a light emitting diode (LED) that emits polychromatic electromagnetic radiation. Between 30 and 100 LEDs can be used in casing 13, preferably about 42. U.S. Patent Application 2005/0048441, which is incorporated herein by reference, discloses light emitting diodes suitable for providing blue light. Other light sources that can be used include incandescent lamps, fluorescent lamps, halogen lamps, xenon lamps, mercury lamps, argon lamps, and ultraviolet lamps. Light can be continuous, interrupted continuous, pulsed or combinations thereof.

The method of the present invention begins with a user applying a film of carbamide peroxide 30 to the surface of the teeth. The user inserts a lens 11 into the mouth, the lens 11 conforms to the curvature of the teeth as shown in FIG. 2. The user holds the lens in place against the teeth by biting down on the bite plate 16 which is attached to the inside surface 15 of lens 11. The user does not need to hold device 10 in place with his or her hands. The user activates a power source to a plurality of LEDs 14 in a casing 13 on the outside surface 12 of lens 11. The LEDs 14 transmit light at a power of 3 to 75 milliwatts/cm² through lens 11 which filters the light so as to deliver blue light in the range of 430 to 450 nanometers to the surface of the teeth. The blue light activates the peroxide at the surface of the teeth such that up to 10 shades of whitening can occur within 15 minutes, without sensitizing or heating the teeth.

The foregoing description has been limited to specific embodiments of this invention. It will be apparent, however, that variations and modifications may be made by those skilled in the art to the disclosed embodiments of the invention, with the attainment of some or all of its advantages and without departing from the spirit and scope of the present invention. For example, transparent dental trays can be used to hold the whitening agents. Accelerators and activators can be added to the whitening agent. Fiber optics can be used to transmit light from the light source. The whitening device of the present invention can be made portable using a portable power supply.

It will be understood that various changes in the details, materials, and arrangements of the parts which have been described and illustrated above in order to explain the nature of this invention may be made by those skilled in the art without departing from the principle and scope of the invention as recited in the following claims.

1. A teeth whitening device, comprising:
a) a lens having an inside surface and an outside surface;
b) a bite plate on said inside surface;
c) a casing on said outside surface, said casing having a plurality of light sources; and
d) said lens being held inside the mouth against the teeth by a user biting on said bite plate.

2. The device of claim 1 wherein said lens filters light from said light sources to produce blue light.

3. The device of claim 2 wherein said blue light is 430 to 450 nanometers.

4. The device of claim 1 wherein said light sources are light emitting diodes.

5. The device of claim 4 wherein said light emitting diodes provide light from about 3 to about 75 milliwatts/cm².

6. A teeth whitening device, comprising:
a) a lens having an inside surface and an outside surface;
b) a bite plate on said inside surface;
c) a casing on said outside surface, said casing having a plurality of light emitting diodes providing light from about 3 to about 75 milliwatts/cm²;
d) said lens being held inside the mouth against the teeth by a user biting on said bite plate; and
e) said lens filtering light from said light emitting diodes to produce blue light having a range of 430 to 450 nanometers.

7. A method of whitening teeth, comprising the steps of:
1) applying a film of carbamide peroxide solution to the surfaces of the teeth;
2) inserting a lens having an inner surface and an outer surface into the mouth;
3) placing said inner surface against the surface of the teeth;
4) holding said lens in place against the teeth by biting down on a bite plate on said inner surface of said lens;
5) activating a plurality of light sources within a casing on the outer surface of said lens so that light is projected from said light sources through said lens producing blue light which is projected onto the surface of the teeth; and
6) activating said carbamide peroxide by said blue light to whiten the surface of the teeth within one hour.

8. The method of claim 7 wherein said blue light is 430 to 450 nanometers.

9. The method of claim 7 wherein said carbamide peroxide solution is 10 to 30%.

10. The method of claim 9 wherein said carbamide peroxide solution is about 21%.

11. The method of claim 7 wherein said light sources are light emitting diodes that project light at 3 to 75 milliwatts/cm².

12. The method of claim 7 wherein the surfaces of the teeth are whitened by 10 shades within 15 minutes.

13. A method of whitening teeth, comprising the steps of:
1) applying a film of 10 to 30% carbamide peroxide solution to the surfaces of the teeth;
2) inserting a lens having an inner surface and an outer surface into the mouth;
3) placing said inner surface against the surface of the teeth;
4) holding said lens in place against the teeth by biting down on a bite plate on said inner surface of said lens;
5) activating a plurality of light emitting diodes that project light at 3 to 75 milliwatts/cm² within a casing on the outer surface of said lens so that light is projected from said light emitting diodes through said lens producing blue light in the range of 430 to 450 nanometers which is projected onto the surface of the teeth; and
6) activating said carbamide peroxide by said blue light to whiten the surface of the teeth within one hour.

14. The method of claim 13 wherein said carbamide peroxide solution is about 21%.

15. The method of claim 13 wherein the surfaces of the teeth are whitened by 10 shades within 15 minutes.

16. The method of claim 14 wherein the surfaces of the teeth are whitened by 10 shades within 15 minutes.
